(19) United States
(12) Patent Application Publication
(10) Pub. No.: US 2013/0161205 A1
(43) Pub. Date: Jun. 27, 2013

(54) METHODS AND DEVICES FOR DETECTING NITROGEN OXIDES

(71) Applicants: Abdul-Majeed Azad, Perrysburg, OH (US); C. William King, Twinsburg, OH (US)

(72) Inventors: Abdul-Majeed AZAD, Perrysburg, OH (US); C. William KING, Twinsburg, OH (US)

(21) Appl. No.: 13/706,682

(22) Filed: Dec. 6, 2012

Related U.S. Application Data
(60) Provisional application No. 61/567,299, filed on Dec. 6, 2011.

(51) Int. Cl. G01N 27/407

(52) U.S. Cl. CPC G01N 27/4071
USPC 205/781; 204/424; 204/408; 204/406

(57) ABSTRACT

A method for detecting nitrogen oxides, the method comprising monitoring the change in potential difference between a working electrode and a reference electrode as the working electrode is exposed to nitrogen oxides, where the working electrode includes an inorganic non-metallic oxide selected from spinel-structured compounds and wolframite-structured compounds, and where the working electrode and the reference electrode are in contact with a solid electrolyte.

### TECHNICAL FIELD

Embodiments of the invention are directed toward methods and devices for detecting nitrogen oxides.

### BACKGROUND ART

Nitrogen oxides, such as nitrogen oxide and nitrogen dioxide, are often referred to as NOx gases. There is a need to detect these gases because they are often produced by the burning of fossils fuels. For example, engines, such as reciprocating engines, diesel engines, and turbine engines, produce NOx gases, and the transportation industries, among others, desire a means to detect the level of these gases in exhaust emissions. Similarly, there is a desire to detect the level NOx in exhaust gases produced by chemical combustion heat engines that produce electrical power, boilers, sintering furnaces, kilns, and foundry.

### SUMMARY OF INVENTION

Embodiments of the present invention provide a method for detecting nitrogen oxides, the method comprising monitoring the change in potential difference between a working electrode and a reference electrode as the working electrode is exposed to nitrogen oxides, where the working electrode includes an inorganic non-metallic oxide selected from spinel-structured compounds and wolframite-structured compounds, and where the working electrode and the reference electrode are in contact with a solid electrolyte.

Further embodiments of the present invention provide a sensor for detecting nitrogen oxides comprising a solid electrolyte, a working electrode disposed on said solid electrolyte, where the working electrode includes a spinel structured compound or a wolframite structured compound, a reference electrode disposed on and in electrical communication with said electrolyte, an ohmic contact in electrical communication with the working electrode, and an electrical detection device that can detect the potential difference between the reference electrode and the working electrode.

Further embodiments of the present invention provide a vehicle comprising an engine and a sensor for detecting nitrogen oxides produced by said engine, the sensor including a solid electrolyte; a working electrode disposed on said electrolyte, where the working electrode includes a spinel structured compound or a wolframite structured compound; a reference electrode disposed on said electrolyte, an ohmic contact disposed said working electrode; and an electrical detection device that can detect the potential difference between the reference electrode and the working electrode.

### BRIEF DESCRIPTION OF THE DRAWINGS

FIG. 1 is a perspective view of a sensor according to one or more embodiments of the present invention.

FIG. 2 is a cross-sectional view of a sensor according to one or more embodiments of the present invention.

### DETAILED DESCRIPTION OF THE ILLUSTRATIVE EMBODIMENTS

Introduction

Embodiments of the invention are based, at least in part, on the discovery of a sensor that can detect the presence and relative amount of NOx within a given environment. It has unexpectedly been found that the potential difference between a reference material (such as a noble metal) and certain inorganic non-metallic oxide compounds (such as those having the spinel structure) in contact with a solid electrolyte is proportionally impacted by the presence of NOx. As a result, one or more embodiments of this invention include potentiometric devices where certain non-metallic oxide compounds are employed as a working electrode. In certain embodiments, the sensors of this invention can advantageously be employed to detect NOx gases emitted by the combustion of fossil fuels.

NOx

In one or more embodiments, the term NOx is employed in its general sense to refer to nitrogen oxides including, but not limited to, nitrogen oxide (NO), nitrogen dioxide (NO₂), as well as derivatives thereof.

General Operation

In one or more embodiments, the sensors include a working electrode (which may also be referred to as a first electrode, working layer, or sensing layer), a solid electrolyte (which may also be referred to as a substrate), and a reference electrode (which may also be referred to as a second electrode or reference layer). A potential difference exists between the working electrode and the reference electrode; the potential difference may also be referred to as a voltage. This potential difference could be created either across the thickness of the solid electrolyte or along the surface of the solid electrolyte onto which the first electrode and reference electrode layers may be deposited. The difference in the rate of electrocatalytic reaction between NOx and the two electrodes is believed to create different current flux at respective electrodes. This in turn generates a potential difference by virtue of different current densities. The presence of NOx impacts the potential difference between the working electrode and the reference electrode. Advantageously, and unexpectedly, the change in potential difference between the working layer and the reference layer is proportional to the concentration of the NOx that is in contact with the working layer. Thus, this change in potential difference can be measured and correlated to the concentration of the NOx to thereby provide a sensor capable of detecting the presence of and concentration of the NOx in contact with the working layer.

Working Electrode

In one or more embodiments, the working electrode is in contact with the environment (e.g. gas) being detect and is therefore in contact with the analyte, which for purposes of this invention is NOx.

In one or more embodiments, the working electrode includes an inorganic non-metallic oxide, which may also be referred to as a working oxide. In certain embodiments, the working electrode may also include a dopant. In one or more embodiments, the working electrode may include a binder material.

In particular embodiments, the working electrode consists essentially of the working oxide compound, optionally a dopant, optionally a binder, or a combination of two or more thereof. By consisting essentially thereof, it is meant that the working electrode does not include other constituents that may impact the basic and novel characteristics of the working layer. In particular embodiments, the working electrode consists of the working oxide (as defined herein), optionally a dopant, optionally a binder, or a combination of two or more thereof. In certain embodiments, the working electrode includes, consists essentially of, or consists of the working oxide (as defined herein), optionally a dopant, and optionally a binder. In one or more embodiments, the working electrode is substantially devoid of a dopant, which refers that amount or less that will not have an appreciable impact on the working electrode. In other embodiments, the working electrode is devoid of a dopant.

In one or more embodiments, the inorganic non-metallic oxides (i.e. working oxide) employed in embodiments of the present invention may include those inorganic non-metallic oxides configured in the spinel structure and/or those inorganic non-metallic oxides configured in the wolframite structure.

Spinel Structured Compounds

In one or more embodiments, inorganic non-metallic oxides configured in the spinel structure include those minerals having the general formulation AB₂O₄, where A and B can be divalent, trivalent, or quadrivalent cations, including, for example, nickel, magnesium, zinc, iron, manganese, aluminum, chromium, beryllium, cobalt, titanium, and silicon. It is believed that at least some of these minerals crystallize in the cubic (isometric) crystal system with the oxide anions arranged in a cubic close-packed lattice and the cations A and B occupying some or all of the octahedral and tetrahedral sites in the lattice.

Specific examples of inorganic non-metallic oxides configured in the spinel structure include spinel (MgAl₂O₄), gahnite (ZnAl₂O₄), franklinite (Zn, Fe, Mn) (Fe, Mn)₂O₄, chromite (FeCr₂O₄), nickel chromite (NiCr₂O₄), chrysoberyl (BeAl₂O₄), and spinel ferrites. In one or more embodiments, useful spinel ferrites have the general formulation M(Fe₂O₄), where M is nickel (Ni), zinc (Zn), or a mixture of nickel and zinc in different ratio between 0 and 1. Specific examples of spinel ferrites include nickel ferrite (NiFe₂O₄), zinc ferrite (ZnFe₂O₄), cobalt ferrite (CoFe₂O₄)and mixed zinc-nickel ferrites (Zn, Ni(Fe₂O₄) at nickel to zinc ratios of between 0 and 1.

Other useful spinel structured compounds are disclosed in U.S. Pat. Nos. 6,641,908, 5,603,908, and 7,839,605 and U.S. Publication No. 2011/0062405, which are incorporated herein by reference.

Wolframite Structured Compounds

In one or more embodiments, the inorganic non-metallic oxides configured in the wolframite structure include those minerals having the general formulation ABO₄, where A and B can be divalent, trivalent, or quadrivalent cations, including, for example, nickel, magnesium, zinc, iron, lead, manganese, aluminum, chromium, beryllium, titanium, and, tungsten, molybdenum, and silicon.

Specific examples of inorganic non-metallic oxides configured in the wolframite structure include tungstates and molybdates. In one or more embodiments, useful tungstates have the general formulation M(WO₄), where M is divalent calcium (Ca), barium (Ba), zinc (Zn), iron (Fe), manganese (Mn) or mixtures of two or more thereof in different ratio between 0 and 1. Specific examples of tungstates include wolframite (Fe, Mn (WO₄)), and scheelite (CaWO₄). In one or more embodiments, useful molybdates have the general formulation M(MoO₄), where M is calcium (Ca), barium (Ba), zinc (Zn), iron (Fe), manganese (Mn) or mixtures of two or more thereof in different ratio between 0 and 1. Specific examples of molybdates include wulfenite (PbMoO₄).

Other useful wolframite structured compounds are disclosed in U.S. Pat. Nos. 6,641,908, 5,603,908, and 7,839,605 and U.S. Publication No. 2011/0062405, which are incorporated herein by reference.

Dopants

In one or more embodiments, dopants include those materials that can change the potential difference between the working layer and the reference layer. It is believed that these materials operate based upon their ability to increase current density. In one or more embodiments, the presence of a dopant within the working layer allows for the detection and determination of relative amount of NOx at much lower concentrations of NOx in contact with the working layer. In one or more embodiments, the dopant increases the potential difference between the working electrode and the reference electrode.

In one or more embodiments, useful dopants include noble metals such as, but not limited to, ruthenium, rhodium, palladium, silver, osmium, iridium, platinum, gold, and mixtures or alloys thereof. In particular embodiments, the dopant is gold. In other embodiments, the dopant is an inorganic non-metallic oxide such as titania, yttria, lanthana, and ceria.

In one or more embodiments, the working electrode may include at least 1 part per million (ppm), in other embodiments at least 100 ppm, and in other embodiments at least 500 ppm of the dopant material. In these or other embodiments, the working electrode may include from about 1 ppm to about 1000 ppm, in other embodiments from about 100 to about 750 ppm, and in other embodiments from about 200 to about 600 ppm of the dopant material.

Binders

In one or more embodiments, the useful binders include those substances that can serve to or assist in binding the particles of working oxide (e.g. spinel or wolframite structured compounds) to one another within the working electrode. In certain embodiments, the binder serves as a matrix in which the working oxide is dispersed. In other embodiments, the binder is co-continuous with the working oxide. In other embodiments, the binder is discretely dispersed in the working oxide. An example of a binder is silicon dioxide (SiO₂), which may also be referred to as silica. As those skilled in the art appreciate, the silica can be introduced into a composition for forming the working layer in the form of an organosilicon compound such as, but not limited to, an alkoxy silane (e.g. tetraorthosilicate), and then converted to silica through firing.

Particle Size

In one or more embodiments, the working oxide is in the form of fine particles within the working electrode. In particular embodiments, the working oxide particles are dispersed as fine particles within the binder to form the working electrode. The particles of the working oxide may be characterized by an average particle size greater than 10 micron, in other embodiments greater than 20 microns, and in other embodiments greater than 30 microns. In these or other embodiments, the particles of the working oxide may be characterized by an average particle size less than 1000 microns, in other embodiments less than 250 microns, and in other embodiments less than 100 microns. In one or more embodiments, the working oxide particles may be characterized by an average particle size of from about 10 to about 1000 microns, in other embodiments from about 15 to about 250 microns, and in other embodiments from about 35 to about 65 microns.

In one or more embodiments, the working oxide particles may be characterized by a maximum particle size of less than 1000 microns, in other embodiments less than 500 microns, in other embodiments less than 250 microns, in other embodiments less than 100 microns, and in other embodiments less than 60 microns.

Electrolyte

In one or more embodiments, the solid electrolyte is in contact with the working electrode and serves as the medium through which or on which a potential difference exists between the working electrode and the reference electrode.

In one or more embodiments, the solid electrolyte is or includes a solid electrolyte that can act as a solid state electronic conductor. It is believed that solid electrolytes operate as ionic conductors by the movement of ions through voids or empty crystallographic positions within the crystal lattice structure of the material.

Superior Oxide Ion Conducting Ceramic

In one or more embodiments, the solid electrolyte is or includes a superionic oxide ion conducting ceramic. Exemplary superionic oxide ion conducting ceramic materials include, but are not limited to, fully yttria stabilized zirconia, partially yttria stabilized zirconia, magnesia stabilized zirconia, scandia stabilized zirconia, gadolinia doped ceria, and zirconia doped ceria.

Useful solid electrolytes are commercially available from a number of sources. For example, yttria stabilized zirconia wafers or substrates having about 8% by weight yttria can be purchased from Fuel Cell Materials Inc.

In one or more embodiments, the potential difference (i.e. voltage) that exists between the working electrode (e.g. layer including nickel ferrite) and the electrolyte (e.g. yttria stabilized zirconia) may be from about 25 to about 250 millivolts, in other embodiments from about 45 to about 125 millivolts, and in other embodiments from about 60 to about 100 millivolts in the absence of a dopant.

Reference Electrode

In one or more embodiments, the reference electrode includes a noble metal such as, but not limited to, ruthenium, rhodium, palladium, silver, osmium, iridium, platinum, and gold, and mixtures of two or more thereof. In particular embodiments, alloys or mixtures of noble metals are employed such as, for example, alloys of silver and palladium. In one or more embodiments, the reference electrode consists of a noble metal or alloy of noble metals. In other embodiments, the reference electrode consists essentially of noble metals or an alloy of a noble metal.

Device for Detecting NOx

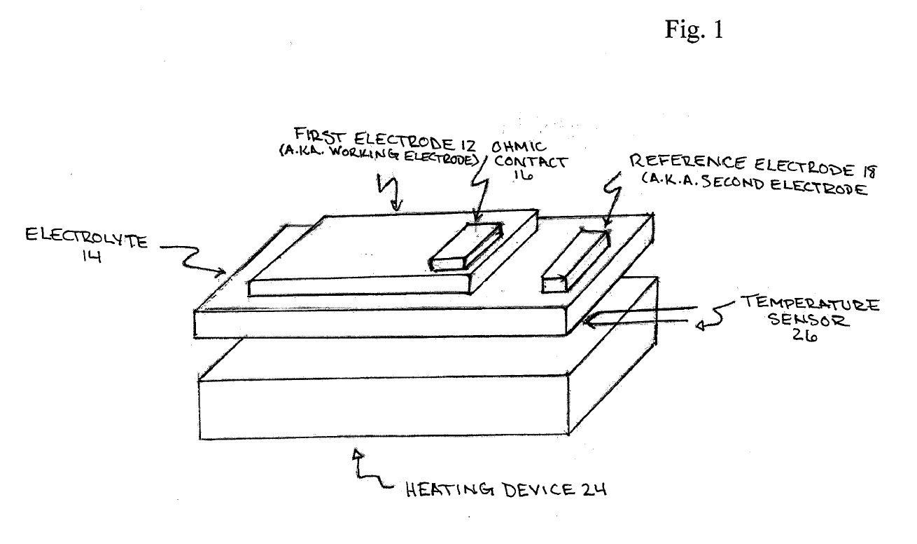

A device for detecting NOx according to one or more embodiments of the present invention can be generally described with reference to FIG. 1. As those skilled in the art will appreciate, FIG. 1, like other figures presented in this specification, is not drawn to scale and is primarily provided to illustrate the relationship of the various elements of the combinations presented.

In one or more embodiments, the sensor is a solid-state potentiometric device 10 that includes a working electrode 12 (which may also be referred to as sensing layer 12 or first electrode 12) disposed on at least a portion of surface 13 of solid electrolyte 14 (which may also be referred to as substrate 14). An ohmic contact 16 (which may also be referred to as first ohmic contact 16) is in electrical communication with working electrode 12. A reference electrode 18 (which may also be referred to as second electrode 18 or second ohmic contact 18) is in electrical communication with electrolyte 14. Ohmic contact 16 and reference electrode 18 are in electrical communication with an electrical detection device 22, which may include, for example, a voltage meter together with other optional devices, such as converters, that may be used to read the potential difference that exists between working electrode 12 and reference electrode 18.

An optional heating device 24 is in thermal communication with electrolyte 14, and a temperature measuring device 26 in thermal communication with electrolyte 14 and/or heating device 24.

As indicated above, working electrode 12 may include the working oxide (e.g. spinel or wolframite structured compounds), optionally together with a dopant (not shown) and/or a binder (not shown).

In one or more embodiments, working electrode 12 may have a thickness (measured for example from the interface 26 between sensing layer 12 and solid electrolyte 14 and the top 28 of the working electrode 12) of from about 10 to about 1000 microns, in other embodiments from about 25 to about 250 microns, and in other embodiments from about 35 to about 100 microns. In these or other embodiments, working electrode 12 has a thickness that is less than 250 microns, in other embodiments less than 100 microns, and in other embodiments less than 60 microns.

As indicated above, electrolyte 14 may include a solid electrolyte (e.g. a superionic oxide ion conducting ceramic) as disclosed above.

In one or more embodiments, electrolyte 14 may have a thickness (measured for example from bottom of the substrate to top surface in contact with the working electrode) of from about 50 to about 1000 microns, in other embodiments from about 100 to about 800 microns, and in other embodiments from about 200 to about 500 microns. In these or other embodiments, reference electrode 14 has a thickness that is less than 750 microns, in other embodiments less than 500 microns, and in other embodiments less than 300 microns.

As is generally known in the art, ohmic contact 16 and reference electrode 18 may be fabricated from and therefore include one or more noble metals such as, but not limited to, ruthenium, rhodium, palladium, silver, osmium, iridium, platinum, and gold, and mixtures of two or more thereof. Practice of the present invention is not limited by the number or type of ohmic contacts employed. In particular embodiments, alloys or mixtures of noble metals are employed such as, for example, alloys of silver and palladium. As those skilled in the art will appreciate, numerous ohms contact designs can be configured. In one or more embodiments, the ohmic contacts have a thickness of from about 10 to about 1000 microns.

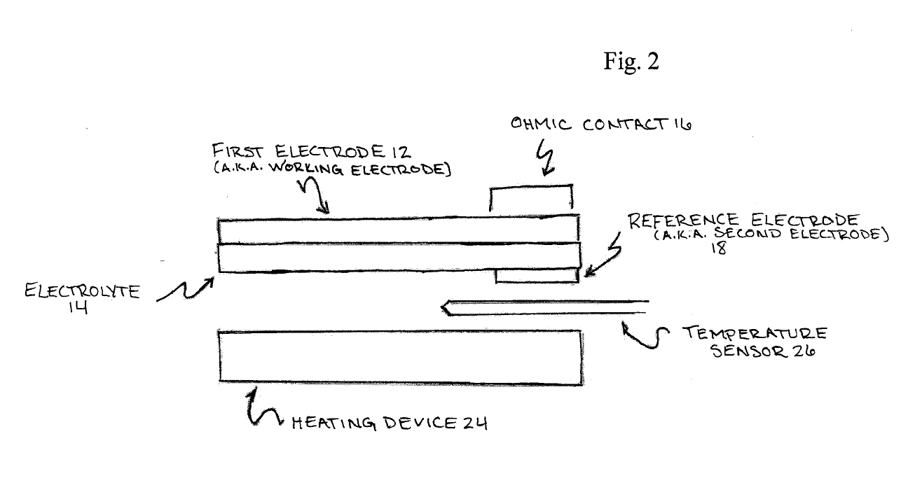

As shown in FIG. 1, first ohmic contact 16 is disposed on working electrode 12 and reference electrode 18 (i.e. second ohmic contact 18) is disposed on electrolyte 14. In the particular embodiment shown in FIG. 1, both ohmic contacts 16, 18 are disposed on the same side (e.g. top) of the sensor device. In other embodiments, as shown in FIG. 2, ohmic contact 16 is disposed on working electrode 12 and reference electrode 18 is disposed on electrolyte 14, but each contact is disposed on opposite sides of working electrode 12 and electrolyte 14.

In one or more embodiments, heating device 24 may be integrated into the electrolyte 14. For example, a nichrome wire may be disposed within a yttria stabilized zirconia wafer. In other embodiments, heating device 24 can include a structure separate from the substrate and can be attached to the substrate using cements known in the art.

Thermal measuring device 26 can include a chromel-alumel (Type K) or a platinum-based resistive temperature detector (RTD), which may be printed on the reference layer.

Method of Fabricating Device

While practice of the present invention is not necessarily limited by the method used to produce the device of one or more embodiments of the present invention, the following method has been found to be advantageous.

The sensors of one or more embodiments of the present invention can be fabricated by applying first preparing a slurry that contains the working oxide (e.g. nickel ferrite) to a water that serves as the electrolyte. This slurry can then be applied to a wafer (e.g. yttria stabilized zirconia) to form a thin film of the slurry on the wafer. The thin film can be applied using several techniques. For example, a thin film can be knife coated (e.g. doctor blade coated) onto the wafer. In other embodiments a thin film can be silk screened on to wafer. In one or more embodiments, the thickness of the film is one to three layers of working oxide particles (e.g. one to three layers of the nickel ferrite). For example, where the spinel particles have an average particle size of 45 microns, a film have a thickness of about 45 to about 135 microns is desired.

Once the thin film has been applied, the wafer (i.e., electrolyte) containing the thin film of slurry (including the working oxide) can be sintered or partially sintered, which may be referred to as firing or baking. In one or more embodiments, firing takes place at temperature is excess of 700° C., in other embodiments in excess of 750° C., and in other embodiments in excess of 800° C. In particular embodiments, firing of the wafer containing the thin film of slurry takes place through a systematic firing scheme where the temperature is ramped over time.

In conjunction therewith, ohmic contacts (including the reference electrolyte) can be applied using techniques known in the art. In one or more embodiments, an ohmic contact is applied to the working electrode and an ohmic contact (i.e., reference electrode) is applied to the wafer (i.e., electrolyte).

Packaging

As those skilled in the art appreciate, the various other sensor configurations can incorporate the sensors of this invention. Moreover, these various devices can be packaged or assembled within various packages known in the art. For example, and without limitation, these devices can be assembled with a stainless steel or ceramic tube or in a hollow threaded bolt.

In one or more embodiments, the sensors of the present invention can be employed without packaging.

### INDUSTRIAL APPLICABILITY

In one or more embodiments, the techniques and devices of the present invention can advantageously be used to detect nitrogen oxides. The devices can both detect the presence of the nitrogen oxides as well as the concentration of the nitrogen oxides within the environment being analyzed. Advantageously, the sensors of one or more embodiments the present invention can operate at temperatures from about ambient temperature to about 800° C., in other embodiments from about 200 to about 700° C., and in other embodiments from about 650 to about 700° C. Also, the sensors of one or more embodiments of the present invention are advantageously capable of detecting nitrogen oxides present at levels within the environment being analyzed at levels from about 1 to about 2,000 parts per million (ppm).

In one or more embodiments, the sensors of the present invention can be employed to detect nitrogen oxides produced by the burning of fossil fuels. In particular, this may include detection within the exhaust gases produced by engines used in the transportation industry such as, but not limited to, reciprocating engines, diesel engines, and turbine engines. In certain embodiments, the sensors can be placed within the exhaust streams of vehicles operating with reciprocating engines. It is contemplated that the sensors of one or more embodiments of this invention can withstand direct exposure to exhaust gas velocities of up to about 10 meters per second. In other embodiments, the sensors can be used to detect NOx in the exhaust gases of chemical combustion heat engines that produce electrical power, boilers, sintering furnaces, kilns, and foundry furnaces.

In other embodiments, the sensors of one or more embodiments of the present invention may be employed with vertical integration assemblies. For example, voltage sensing electronics, with and without digitizing, and transmission of serial data, and temperature controllers.

### EXPERIMENTAL SECTION

Nickel oxide (NiO) powder and ferric oxide (Fe₂O₃) powder were mixed together in a 1:1 molar ratio in a large beaker. Enough acetone was added to cover the mixture. The mixture was stirred for 15 minutes until the powders were thoroughly mixed. The mixture was dried on a hotplate at 70° C. to drive off the acetone. The resultant dry mixture was broken up into powder.

This powder (which was an intimate mixture of NiO and Fe₂O₃) was heated in a quartz container at 800° C. for 4 hours to form nickel ferrite (NiFe₂O₄). The resultant material was allowed to cool and was ground with a mortar and pestle. This material was then heated again in a quartz container at 800° C. for 4 hours and then allowed to cool.

To determine if the desired reaction took place, a magnet is placed the vicinity of the material and the response noted. NiFe₂O₄ is paramagnetic and drawn to the magnet, while NiO and Fe₂O₃ are not. It was determined that the resultant material was substantially converted to NiFe₂O₄. X-ray diffraction analysis of the compound confirmed the formation of nickel territe.

The NiFe₂O₄ was ground in a ball mill with media so that the particles would fit through a 325 mesh (45 microns). A 325 mesh sieve was used to verify particle size.

A paste with suitable rheology was prepared by adding heptanol to the NiFe₂O₄ powder to form a slurry including approximately 40% by weight solvent and approximately 60% by weight solids. To this slurry was added approximately 3% by weight tetraethyl orthosilicate (TEOS), which served as a binder, to form a NiFe₂O₄ paste.

The NiFe₂O₄ paste was pushed through a silkscreen onto a yttrium (8%) stabilized zirconia wafer, coating only one side, with the desired size of the sensor.

Multiple sensors are made on one YSZ layer at a time with an appropriate silkscreen pattern.

The resultant two layer device is fired as follows: ramp from 20° C. to 150° C. at 3° C. per minute; hold at 150° C. for 30 minutes; ramp from 150° C. to 350° C. at 3° C. per minute; hold at 350° C. for 1 hour; ramp from 350° C. to 800° C. at 3C per minute; hold at 800° C. for 1 hour; ramp to 20° C. at 3C per minute.

Two ohmic contacts, made of sliver-palladium paste, were applied to the two layer device, one contact on the NiFe₂O₄ layer and one contact on the YSZ layer, which will serve as the reference electrode.

The resultant device was fired as follows: dry at 150C for 10-15 minutes; fire at a peak temperature of 850C for 10 minutes; total cycle time is 30-60 minutes.

The devices were then singluated and steel wires were bonded to each of the ohmic contacts of the singulated devices. The reference layer of each singluated device was cemented, with a high-temperature cement, to a heater element, capable of reaching 700° C., with a Type K thermocouple between them.

The steel wires were attached to a volt meter. The Type K thermocouple and the heater element were connected to a temperature feedback loop controller.

The controller operating setpoint was set at 550° C., the sensor was brought to this temperature and held there, and the voltage was measured at 0 ppm and 100 ppm NOₓ atmospheres.

Although the present invention has been described in considerable detail with reference to certain embodiments, other embodiments are possible. Therefore, the spirit and scope of the appended claims should not be limited to the description of the embodiments contained herein.

What is claimed is:

1. A method for detecting nitrogen oxides, the method comprising:
monitoring the change in potential difference between a working electrode and a reference electrode as the working electrode is exposed to nitrogen oxides, where the working electrode includes an inorganic non-metallic oxide selected from spinel-structured compounds and wolframite-structured compounds, and where the working electrode and the reference electrode are in contact with a solid electrolyte.

2. The method of the preceding claim, where the working electrode includes a ferrite.

3. The method of any one of the preceding claims, where the working layer includes a tungstate.

4. The method of any one of the preceding claims, where the solid electrolyte is a superionic oxide ion conducting ceramic.

5. The method of any one of the preceding claims, where the solid electrolyte is yttria stabilized zirconia.

6. The method of any one of the preceding claims, where the working electrode includes a dopant.

7. The method of any one of the preceding claims, where the inorganic non-metallic oxide is in the form of particulate having an average particle size of from 10 to 1000 microns.

8. The method of any one of the preceding claims, where the working electrode includes nickel ferrite.

9. The method of any one of the preceding claims, where, in the absence of nitrogen oxides, the potential difference between the working electrode and the reference electrode is from about 25 to about 250 millivolts.

10. The method of any one of the preceding claims, where the nitrogen oxides are NOx.

11. A sensor for detecting nitrogen oxides comprising:
a solid electrolyte;
a working electrode disposed on said solid electrolyte, where the working electrode includes a spinel structured compound or a wolframite structured compound;
a reference electrode disposed on and in electrical communication with said electrolyte;
an ohmic contact in electrical communication with the working electrode; and
an electrical detection device that can detect the potential difference between the reference electrode and the working electrode.

12. The sensor of the preceding claim, further comprising a heating device in thermal communication with the electrolyte.

13. The sensor of any one of the preceding claims, further comprising a temperature measuring device in thermal communication with said electrolyte, said heating device, or both said electrolyte and said heating device.

14. The sensor of any one of the preceding claims, where the working electrode includes a spinel structured compound and the spinel structured compound is a ferrite.

15. The sensor of any one of the preceding claims, where the working electrode includes a wolframite structured compound and the wolframite structured compound is a tungstate.

16. The sensor of any one of the preceding claims, where the spinel structured compound is nickel ferrite.

17. The sensor of any one of the preceding claims, where the spinel structured compound or the wolframite structured compound is in the form of particles having an average particle size of from 10 to about 1000 microns.

18. The sensor of any one of the preceding claims, where the thickness of the working electrode is less than 1000 microns.

19. The sensor of any one of the preceding claims, where the thickness of the working electrode is less than about 100 microns.

20. The sensor of any one of the preceding claims, where the electrolyte is a superionic oxide ion conducting ceramic material.

21. A vehicle comprising:
an engine; and
a sensor for detecting nitrogen oxides produced by said engine, the sensor including a solid electrolyte; a working electrode disposed on said electrolyte, where the working electrode includes a spinel structured compound or a wolframite structured compound; a reference electrode disposed on said electrolyte, an ohmic contact disposed said working electrode; and an electrical detection device that can detect the potential difference between the reference electrode and the working electrode.

22. The vehicle of the preceding claim, where the engine is a reciprocating engine.

23. The vehicle of any of the preceding claims, where the engine is a diesel engine.

24. The vehicle of any of the preceding claims, where the engine is a turbine engine.

25. The vehicle of any of the preceding claims, where the sensor is positioned within the exhaust stream exiting the engine.

26. The method of any of the preceding claims, where the reference electrode includes a noble metal.

27. The sensor of any of the preceding claims, where the reference electrode includes a noble metal.

28. The vehicle of any of the preceding claims, where the reference electrode includes a noble metal.
